(19) United States
(12) Patent Application Publication
(10) Pub. No.: US 2002/0092026 A1
(43) Pub. Date: Jul. 11, 2002

(54) Method and apparatus for broadcast delivery of content to a client-side cache based on user preferences

(75) Inventors: James P. Janniello, Fairfield, CT (US); Christopher Ward, Glen Ridge, NJ (US)

Correspondence Address: Ryan, Mason & Lewis, LLP, 1300 Post Road, Suite 205, Fairfield, CT, 06430, US

(73) Assignee: International Business Machines Corporation, Armonk, NY (US)

(21) Appl. No.: 09/929,555

(22) Filed: Aug. 14, 2001

Related U.S. Application Data
(60) Provisional application No. 60/260,594, filed on Jan. 9, 2001.

(51) Int. Cl. H04N 7/025; H04N 7/10; G06F 3/00; H04N 5/445; G06F 13/00; H04N 7/173

(52) U.S. Cl. 725/86; 725/87; 725/45; 725/46

(57) ABSTRACT

A method and apparatus are disclosed for the selection of digital content for broadcast delivery to multiple users. A broadcast edge cache server selects content for broadcast distribution to multiple users. Each user filters the received content for storage in a client-side cache based on user preferences. Each client computer includes a local cache that records material that has been accessed by the user and a broadcast cache that records material that is predicted to be of interest to the user, in accordance with the present invention. Each client computer is connected to the network environment by a relatively high bandwidth uni-directional broadcast channel, and a second bi-directional channel, such as a lower bandwidth channel. A client initially determines if requested content is available local in a client cache or a broadcast cache before requesting the content over the network from an edge server or the content provider (such as a web site) on a lower bandwidth channel.

### CROSS REFERENCE TO RELATED APPLICATIONS

This application claims the benefit of U.S. Provisional Application No. 60/260,594, filed Jan. 9, 2001.

### FIELD OF THE INVENTION

The present invention relates generally to the fields of filtering and selecting broadcast information for storage in caches and, more particularly, to methods and apparatus for selection and storage of digital content in a server cache for subsequent broadcast delivery to multiple users, and the filtering and storage of this information in a client-side cache based on user preferences.

### BACKGROUND OF THE INVENTION

The delivery of digital content over broadcast channels is well known. For example, U.S. Pat. No. 6,021,419, entitled “System for Filtering Broadcast Digital Information In Accordance With Channel Identifiers Stored In Preference List Which Can Be Dynamically Updated Via Command Through Network,” hereinafter, referred to as the “Clarke et al. Patent,” assigned to the assignee of the present invention and incorporated by reference herein, discloses a typical satelllite-based broadcast distribution system. The Clarke et al. Patent may also be applied in the context of a terrestrial broadcast system.

The Clarke et al. Patent discloses a filtering technique that may be employed to deliver user-specific content over such broadcast channels. Generally, each client computer includes a filter adapter that has a preference list identifying one or more channels that the computer is capable of receiving. In addition, a user can configure a category list to identify the channels of interest based on the nature of the transmitted content on the respective channel and thereby further narrow the channels of interest. A filtering process monitors incoming content and discards any message that does not have a source identifier in the source field that matches one of the channel identifiers on the preferences list or is not associated with a designated category of interest.

A number of systems have been proposed or suggested that distributed user-specific information over a network based on user preferences. PointCast, for example, is system where one or more clients periodically send a query to one or more servers for various selected categories of information. Here, each user requests a separate copy of the information and therefore network bandwidth is used to send the requested information to each user. In addition, network bandwidth is used to send each of the user requests to the server using point-to-point connections. Thus, user requests are not aggregated and efficient delivery of the material over a broadcast channel is not attempted.

In order to more efficiently deliver content over a large network, such as the Internet, and to thereby improve content delivery times, caching techniques are often employed. For example, most client computers maintain a cache of recently accessed Web pages. In addition, many Internet Service Providers (ISPs) maintain one or more edge servers on the edge of their networks, such as Akamai servers commercially available from Akamai Technologies, Inc. In this manner, requested content can be presented to a user more efficiently if the requested content can be retrieved from the local cache or an edge cache. The requested content is only obtained from the actual server of the content if the requested content is not found in the local cache or an edge cache.

While conventional caching techniques have effectively reduced content delivery times, they suffer from a number of limitations, which if overcome, could further reduce response times and network traffic. Specifically, conventional caching techniques are limited to material that the client has previously requested or is stored at the “edge” of network. A need therefore exists for a client-side caching mechanism that allows content to be broadcast to multiple users. A further need exists for a broadcast-based caching mechanism that maintains content in a client-side cache based on user preferences. Yet another need exists for a server that broadcasts information for caching to multiple users based on the popularity of the content. Another need exists for a method and apparatus that selects and delivers digital content to multiple users over a broadcast channel such that the content is of interest to the widest possible audience.

### SUMMARY OF THE INVENTION

Generally, a method and apparatus are disclosed for the selection of digital content for broadcast delivery to multiple users. A broadcast edge cache server selects content for broadcast distribution to multiple users, for example, based on a statistical analysis of recent user requests for content. Each user filters the received content for storage in a client-side cache based on user preferences.

Each client computer includes a local cache that records material that has been accessed by the user and a broadcast cache that records material that is predicted to be of interest to the user, in accordance with the present invention. Each client computer is connected to the network environment by a relatively high bandwidth uni-directional broadcast channel, and a second bi-directional channel, such as a lower bandwidth channel to the World Wide Web. A client initially determines if requested content is available in a local client cache (Step 1) or a local broadcast cache (Step 2) before requesting the content from the edge server (Step 3) or the web site 220 (Step 4) on the lower bandwidth channel.

A more complete understanding of the present invention, as well as further features and advantages of the present invention, will be obtained by reference to the following detailed description and drawings.

### DESCRIPTION OF THE DRAWINGS

FIG. 1 illustrates a network environment 100 in which the present invention can operate;

FIG. 2 illustrates the flow of information according to the present invention in further detail;

FIG. 3 is a schematic block diagram showing the architecture of an exemplary client computer of FIG. 1;

FIG. 4 is a schematic block diagram showing the architecture of an exemplary broadcast edge cache server of FIG. 1;

FIG. 5 is a sample table from the URL Table of FIG. 4;

FIG. 6 is a flowchart describing an exemplary implementation of the URL table maintenance process of FIG. 4;

FIG. 6A is a flowchart describing an exemplary implementation of the compute URL Table Limit subroutine, performed by the URL table maintenance process of FIG. 6;

FIG. 7 is a flow chart describing an exemplary implementation of the broadcast download scheduling process of FIG. 4;

FIG. 8 illustrates a data structure for the delivery of category-enhanced web pages in accordance with the present invention;

FIG. 9 is a flow chart describing an exemplary implementation of the cache maintenance process of FIG. 3; and

FIG. 10 is a flow chart describing an exemplary implementation of the web request handling process of FIG. 3.

### DETAILED DESCRIPTION OF PREFERRED EMBODIMENTS

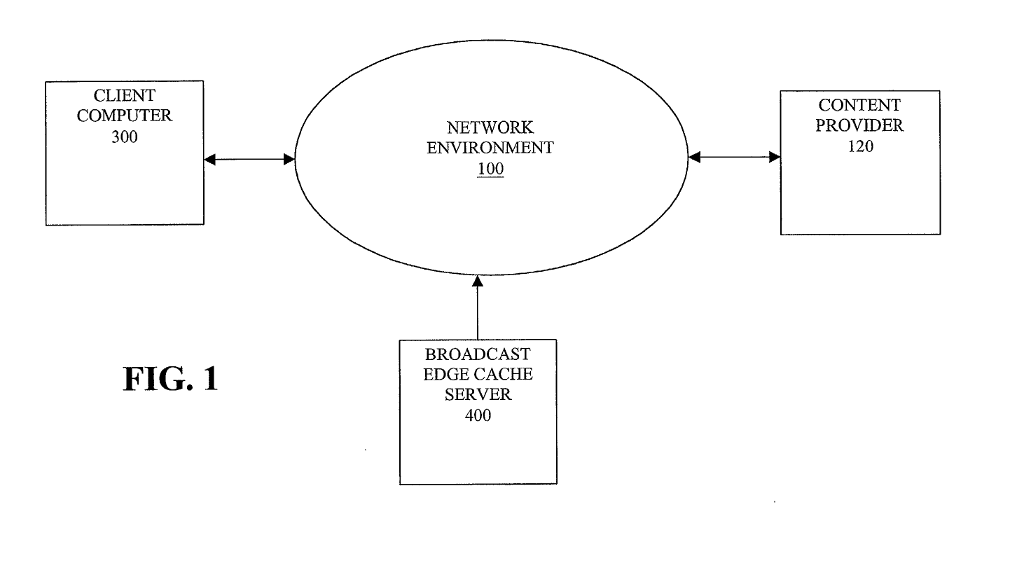

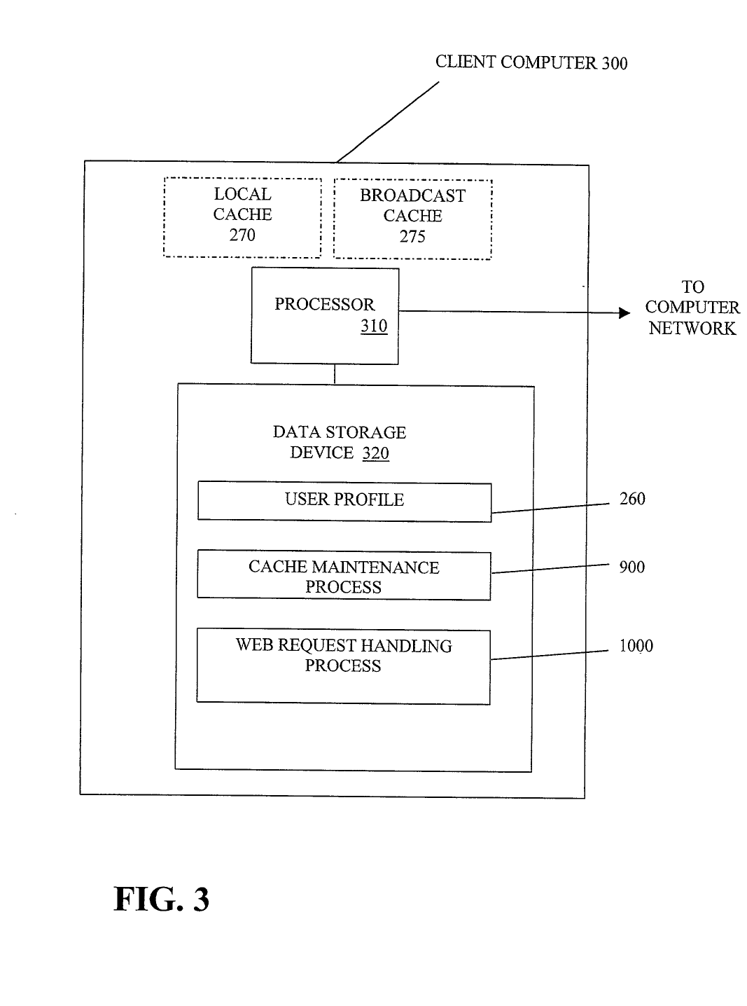

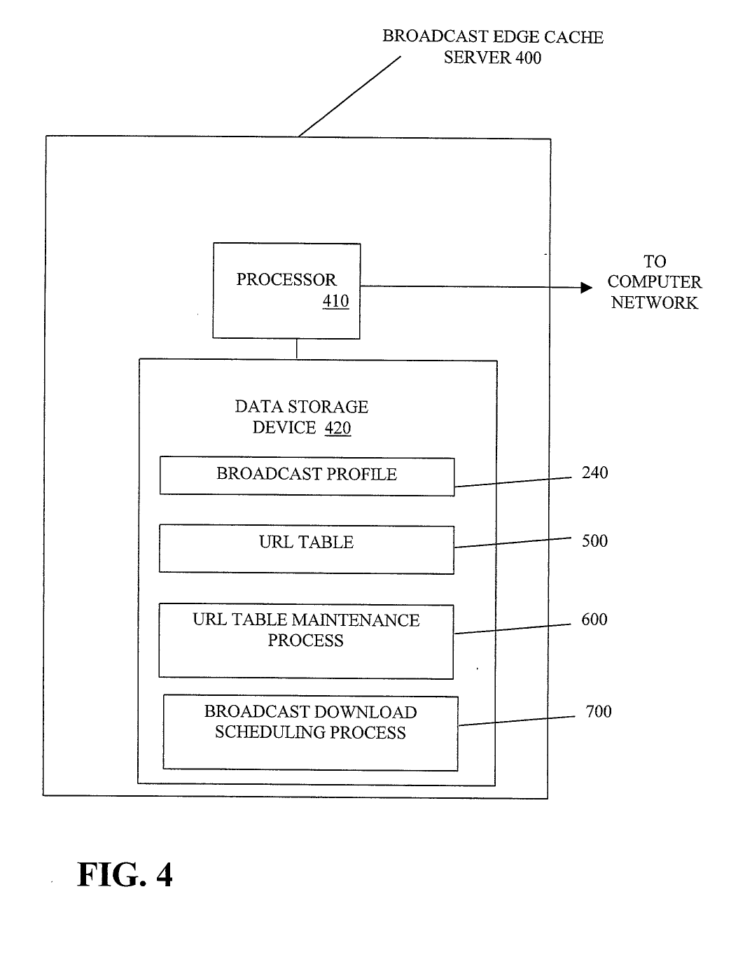

FIG. 1 illustrates a network environment 100 in which the present invention can operate. The present invention permits efficient web browsing that is improved by the broadcast delivery of content for client-side caching. As shown in FIG. 1, a user employing a client computer 300, discussed below in conjunction with FIG. 3, accesses content provided by a content provider 120 over a network 100, discussed below. A broadcast edge cache server 400, discussed further below in conjunction with FIG. 4, delivers content over a broadcast channel (not shown in FIG. 1) to a large number of clients, including the exemplary client computer 300.

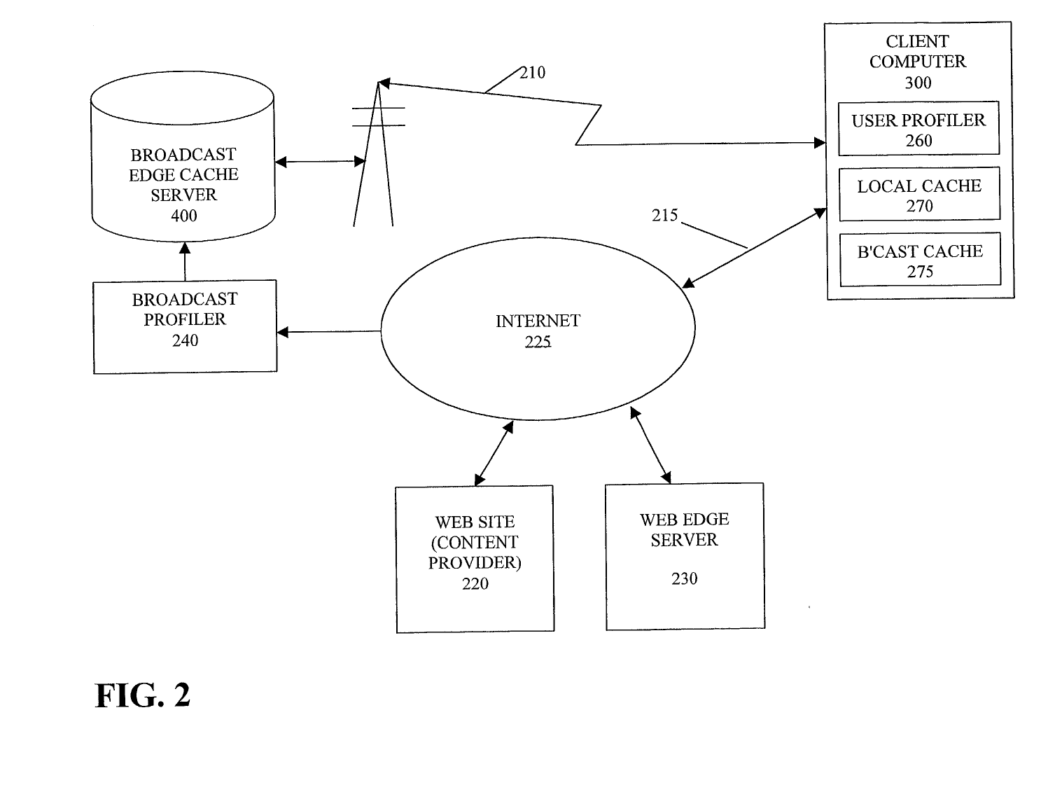

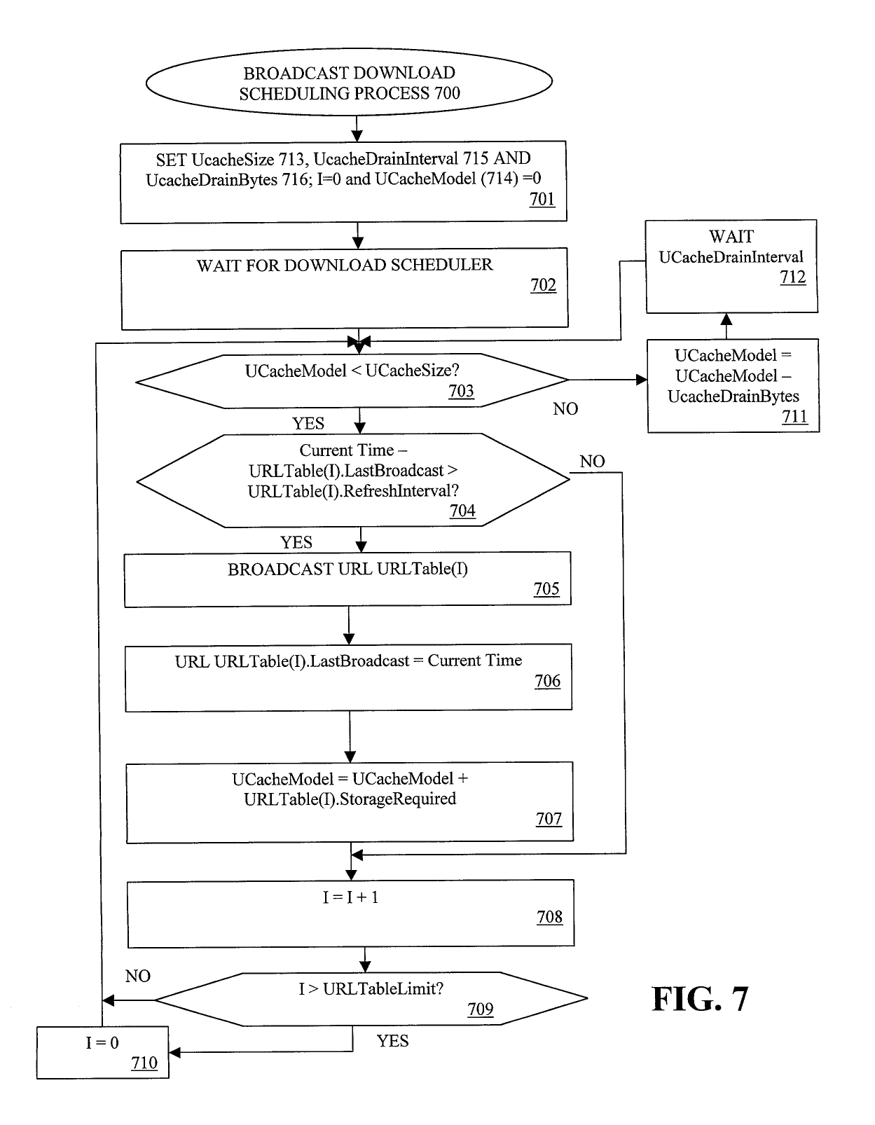

FIG. 2 illustrates the flow of information according to the present invention in further detail. According to one aspect of the present invention, the broadcast edge cache server 400 delivers content over a broadcast channel 210 to a large number of clients, including the exemplary client computer 300. The broadcast edge cache server 400 selects content from materials made available by traditional web servers 220, such as a web site, and web edge servers 230, such as an Akamai server, and other sources, based on a broadcast profile employed by a broadcast profiler 240. As discussed below in conjunction with FIG. 8, the broadcast material may optionally be enhanced with filtering metadata and transported over the broadcast channel 210 to the clients, such as client 300.

The broadcast edge cache server 400 delivers the selected content predictively (i.e., in anticipation of its need by one or more clients) to clients as a supplement to other requested program material. The material will typically be repeated periodically in a downstream broadcast channel 210 with a frequency based on some optimization function, as described below. The output of the broadcast edge cache server 400 can be included in the broadcast channel, e.g., MPEG-2 Transport Multiplex, via a station device such as an emission multiplex (not shown). The data may be inserted or synchronized with the program material in some way.

The output of the emission multiplex is sent to the broadcast channel 210, e.g., a transmitter, for delivery to the user 300. Each client computer 300 stores a subset of this material based on a user profile 260. One embodiment of the delivery of web based pages from the broadcast edge cache server 400 to the client broadcast cache 275 can be supported using the filtering system described in U.S. Pat. No. 6,021,419 (the Clarke et al. Patent), incorporated by reference above. This embodiment will be described below, to the extent relevant, but is only one of many possible ways in which the content may be delivered.

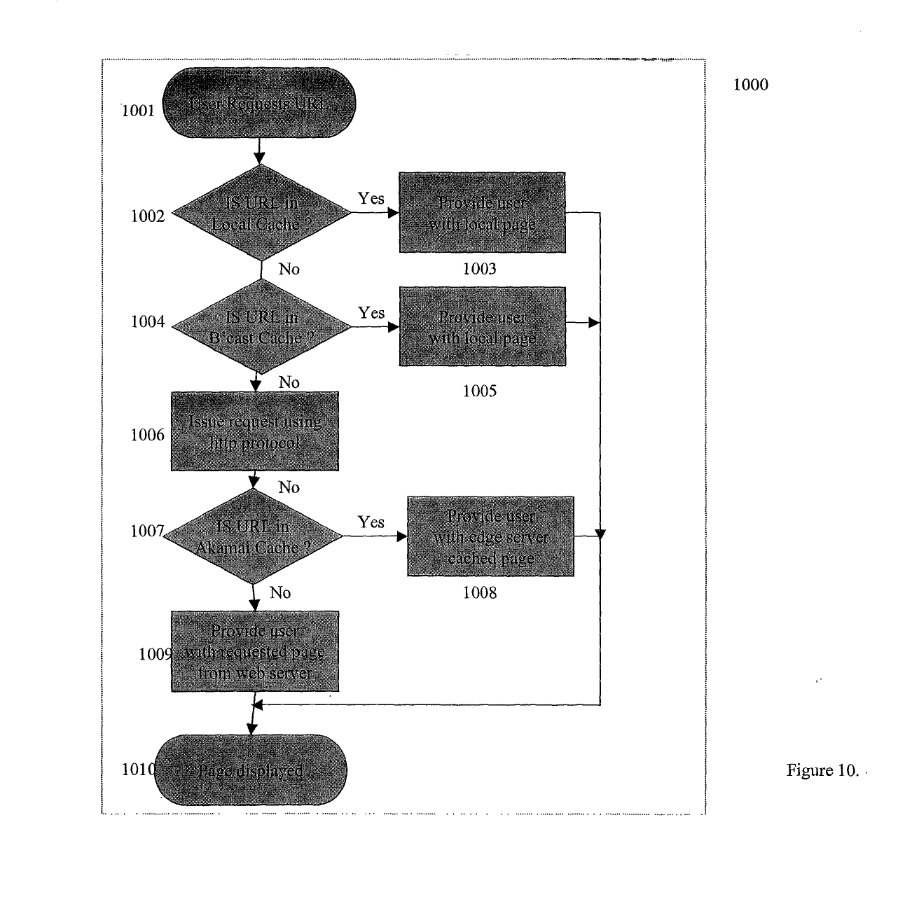

The network environment 100 of FIG. 1 may be embodied as any wired or wireless satellite or terrestrial network, or a combination thereof, such as the Internet, Multichannel Multipoint Distribution Service (MMDS) or Local Multipoint Distribution Service (LMDS) networks, Public Switched Telephone Network (PSTN), a digital satellite network or a 2.5G & 3G Wireless Networks, Wireless Access Protocol (WAP). Generally, each client 300 is connected to the network environment 100 by a relatively high bandwidth uni-directional broadcast channel, such as the channel 210, and a second bi-directional channel, such as a lower bandwidth dial-up PSTN channel 215 to the Internet 225. As discussed further below in conjunction with FIG. 10, the client 300 initially determines if desired content is available in a local client cache 270 (Step 1) or a local broadcast cache 275 (Step 2) before requesting the content from the edge server 230 (Step 3) or the web site 220 (Step 4) on the lower bandwidth channel 215. The local cache 270 records material that the user has already accessed and the broadcast cache 275 records material that is predicted to be of interest to the user, in accordance with the present invention.

The present invention recognizes that there are trade-offs associated with the performance of the system as it pertains to the size of the client's broadcast cache 275, client usage patterns and the amount of data that is sent from the broadcast edge cache server 400. In general, the larger the broadcast cache 275, the more material that will be available to the client without the need to go to the web. A typical size for the broadcast cache 275 is on the order of several megabytes. Generally, the more closely correlated the usage pattern of many users, the more effective the approach, since the broadcast channel reaches many users at once and therefore is more effectively filing their caches if they have common interests. It is noted, however, that the interests of each user will vary somewhat, so, only some fraction of the material broadcast by the broadcast edge server 400 will be applicable to any one user. In one exemplary implementation, for example, the content broadcast by the broadcast edge server 400 might be 150 MB, while the broadcast cache 275 of a given user is only 20 MB of information.

FIG. 3 is a schematic block diagram showing the architecture of an exemplary client computer 300. The client computer 300 may be embodied as a general purpose computing system, such as the general purpose computing system shown in FIG. 3. The client computer 300 includes a processor 310 and related memory, such as a data storage device 320, which may be distributed or local. The processor 310 may be embodied as a single processor, or a number of local or distributed processors operating in parallel. The data storage device 320 and/or a read only memory (ROM) are operable to store one or more instructions, which the processor 310 is operable to retrieve, interpret and execute. As previously indicated, each client computer 300 contains a local cache 270, a broadcast cache 275 and a user profile 260 in accordance with the present invention.

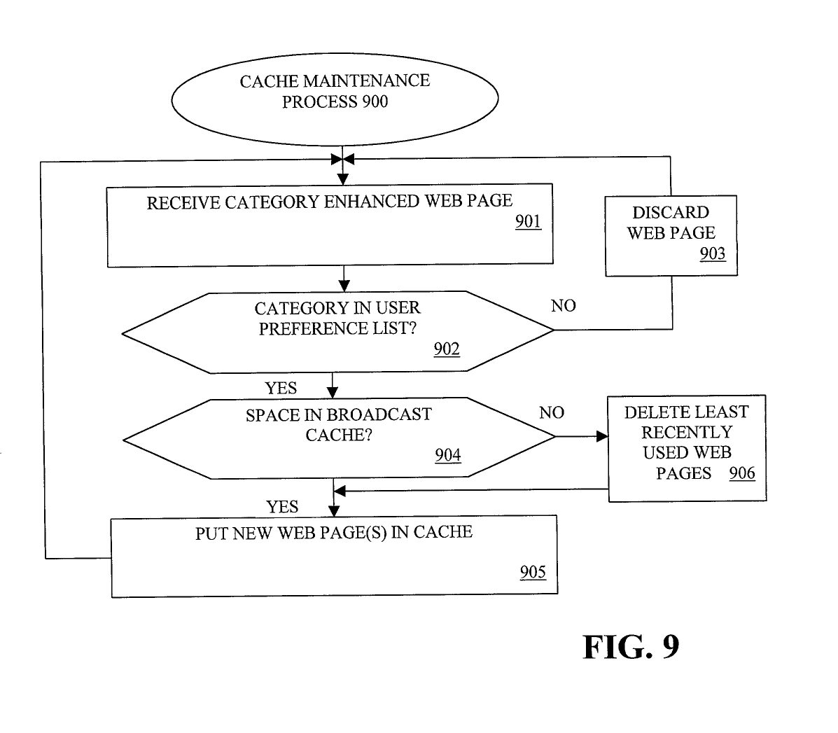

As shown in FIG. 3, and discussed further below in conjunction with FIGS. 9 and 10, the data storage device 320 of each client computer 300 contains a cache maintenance process 900 and a web request handling process 1000. Generally, the cache maintenance process 900 selects the broadcast material that will be stored in the broadcast cache 275. The web request handling process 1000 obtains requested content in accordance with the present invention by determining if it is available in the local cache 270 or broadcast cache 275 before accessing the edge server cache 230 or the original web site 220.

FIG. 4 is a schematic block diagram showing the architecture of an exemplary broadcast edge cache server 400. The broadcast edge cache server 400 may be embodied as a general purpose computing system or server, such as the server system shown in FIG. 4. The broadcast edge cache server 400 includes a processor 410 and related memory, such as a data storage device 420, which may be distributed or local. The processor 410 may be embodied as a single processor, or a number of local or distributed processors operating in parallel. The data storage device 420 and/or a read only memory (ROM) are operable to store one or more instructions, which the processor 410 is operable to retrieve, interpret and execute. As previously indicated, the broadcast edge cache server 400 contains a broadcast profile 240 in accordance with the present invention.

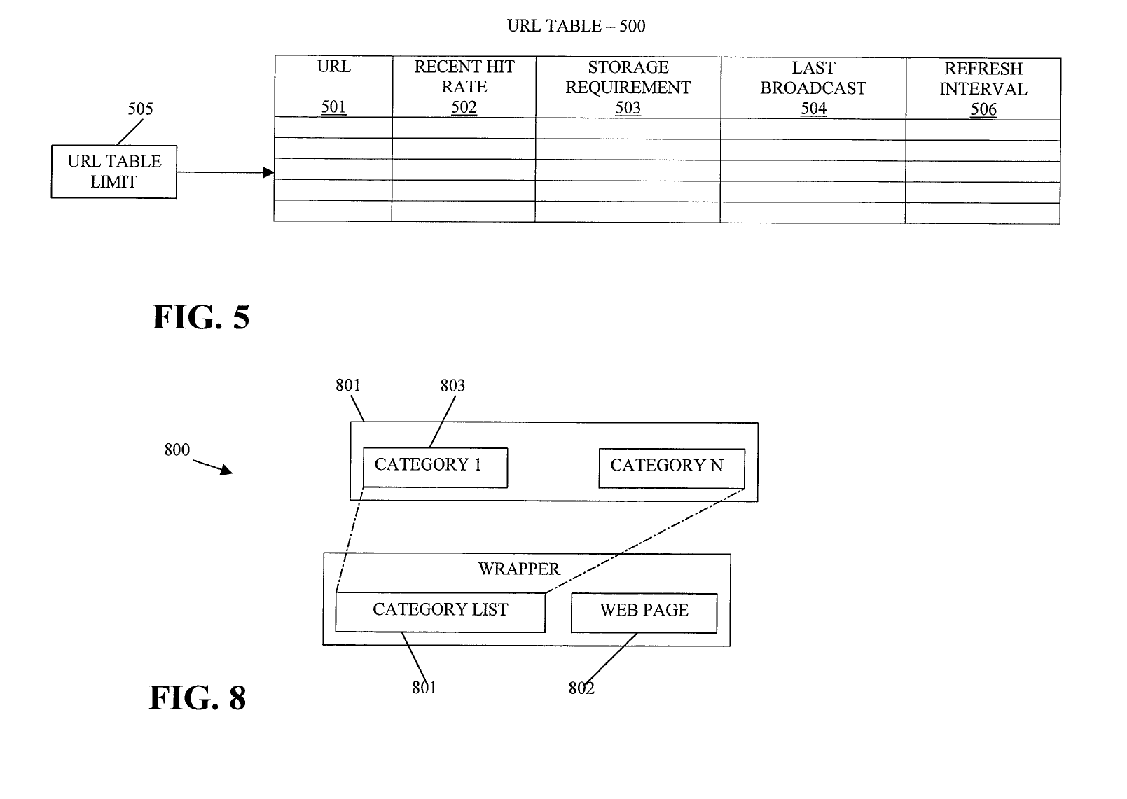

As shown in FIG. 4, and discussed further below in conjunction with FIGS. 5 through 7, the data storage device 420 of the broadcast edge cache server 400 contains a URL table 500, a URL table maintenance process 600 and a broadcast download scheduling process 700. Generally, the URL table 500 records statistics on each URL that is utilized by the broadcast download scheduling process 700 to identify the content that should be broadcast to each client 300. The URL table maintenance process 600 is employed to maintain the URL table 500 of FIG. 5. The broadcast download scheduling process 700 is employed to determine which content to broadcast. Thus, the URL table maintenance process 600 is responsible for updating entries in the URL table 500 and the broadcast download scheduling process 700 is responsible for issuing pages to be delivered over the broadcast medium based on the information available in the URL table 500.

In one exemplary implementation, the broadcast edge cache server 400 (or a separate broadcast profiler) generates the broadcast profile 240 based on recent user requests. The broadcast edge cache server 400 monitors such recent user URL requests using a protocol dialogue between the web edge server 230 and the broadcast profile 240 that passes the most popular URLs and web pages that are provided by the web edge server 230. For example, the web edge server 230 might provide a list of the most popular sites that is used by the broadcast profiler 240 to selectively transmit the most popular web pages for storage in the client-side broadcast cache 275.

In a further variation, the broadcast edge cache server 400 can be made aware of an aggregation of user URL requests by communicating user profiles 260 from each client computer 300 to the broadcast edge server 400. In this manner, a protocol dialogue takes place to pass the most popular web URLs and Web Pages that are provided by the user (via the User Profiler) to the broadcast profiler 240. For example, the user profiler 260 might provide a list of the users most popular sites, this list is then used by the Broadcast Profiler, in conjunction with others users profiles to form an aggregation of popular material. The DTV edge server then selectively transmits these pages in accordance with the broadcast schedule to be potentially put into the client side broadcast cache. The benefit of this approach is that users apparent access to the web is again even faster than that of the Web Edge Server model since the material has been preemptively loaded over the broadcast channel.

The broadcast profiler 240 makes use of a URL table 500, shown in FIG. 5, to represent cache relevance. The URL table 500 maintains a plurality of records, each associated with a different URL in the illustrative embodiment. For each URL identified in field 501, the URL table 500 indicates the recent hit rate in field 502, the storage requirement in field 503 and the last broadcast in field 504. The URL table 500 is generally sorted by the recent hit rate in field 502, so that the most popular URLs are on the top of the table 500. Generally, the URL field 501 contains a unique handle or identifier for a particular content, such as a complete web page or a portion thereof. The actual content associated with the URL is presumed to be either on a server local to the broadcast edge cache server 400 or at some remote location. The recent hit rate field 502 contains a value representing the hit rate for this particular URL over some recent period. It is assumed that the recent hit rate is a real number in the range [0 . . . 1], where a value of zero indicates a very low hit rate and a value of one indicates a very high hit rate. The storage requirement field 503 indicates the size of content referred to by the URL (typically in bytes). A value of zero can be used if the size of the content is unknown. The last broadcast field 504 indicates the date and time at which this content was last delivered on the broadcast channel 210. The refresh interval field 506 indicates how often each content item should be retransmitted. In addition, a single state variable (discussed below), referred to as the URL Table Limit 505, will track a limit on the entries that are delivered over the broadcast channel over time.

### Server-Side Processes

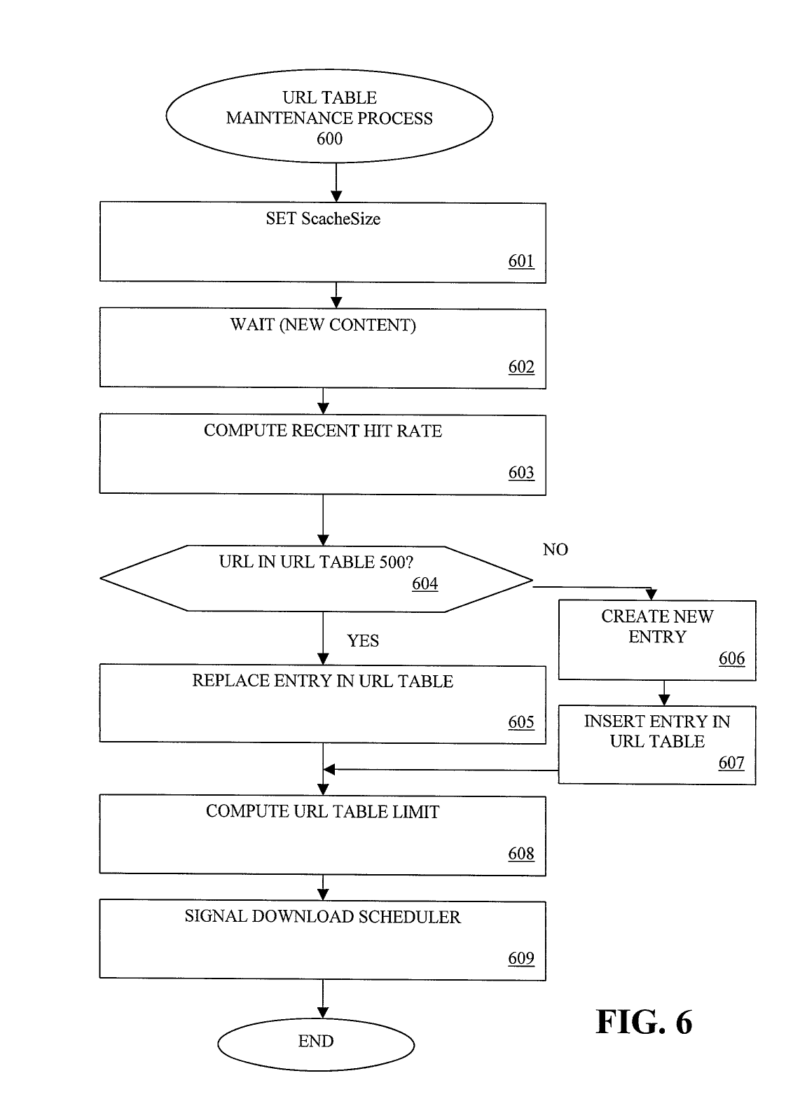

FIG. 6 is a flowchart describing an exemplary implementation of the URL table maintenance process 600. As previously indicated, the URL table maintenance process 600 maintains the URL table 500. As shown in FIG. 6, a state variable, ScacheSize, is set during step 601 to a limit by an edge server operator (based, e.g., on company policy decisions). The state variable, ScacheSize, reflects the size of an imagined Server cache associated with the broadcast edge cache server 400. The algorithm operates as follows. The state variable, ScacheSize, defines the number of bytes over which the broadcast edge cache server 400 will carousel. That is, over time, the first n entries in the URLTable 500 whose accumulated storage requirements do not exceed the state variable, ScacheSize, will be repeatedly broadcast. During step 602, the process 600 waits for new content to arrive by some external process (e.g., information update from an edge server cache). This information can be acquired from many sources and is not explained further here.

When content arrives, the URL table maintenance process 600 moves to step 603 at which point the normalized recent hit rate field 502 for this content is computed. This value may be acquired from the same source as the content itself (e.g., from an edge server cache) or may be computed by the URL table maintenance process 600. In an exemplary implementation, the recent hit rate is computed by dividing the number of URL hits (as measured by the cache over the past hour) by the previous all time peak rate for any URL over any hour.

During step 604, the URL associated with the new content is compared with those in the URL table 500, for example, using any of a number of indexing/hashing algorithms. If the URL is in the URL Table 500, then the entry in the URL table 500 is replaced during step 605 with details corresponding to the new content (i.e., the recent hit rate field 502 is set to the computed recent hit rate, the storage requirement field 503 is set to the size of the content, the last broadcast field 504 is set to 0 indicating that this has not been broadcast and the refresh interval 506 is set to the desired frequency with which this material should be broadcast). If the URL is not in the URL Table 500, however, then a new entry is created during step 606, that is populated with the information from the new content, that is, the URL field is assigned to the URL, the “recent hit rate” field is set to the computed recent hit rate, the “storage requirement” field is set to the size of the content and the “last broadcast” field is set to 0 indicating that this has not been broadcast.

During step 607, the new table entry is inserted into the existing table 500. Table entries in the URL Table can be first ordered by recent hit rate (highest first), then ordered by storage requirement (smallest first), and finally alphabetically by URL. The process then proceeds to step 608.

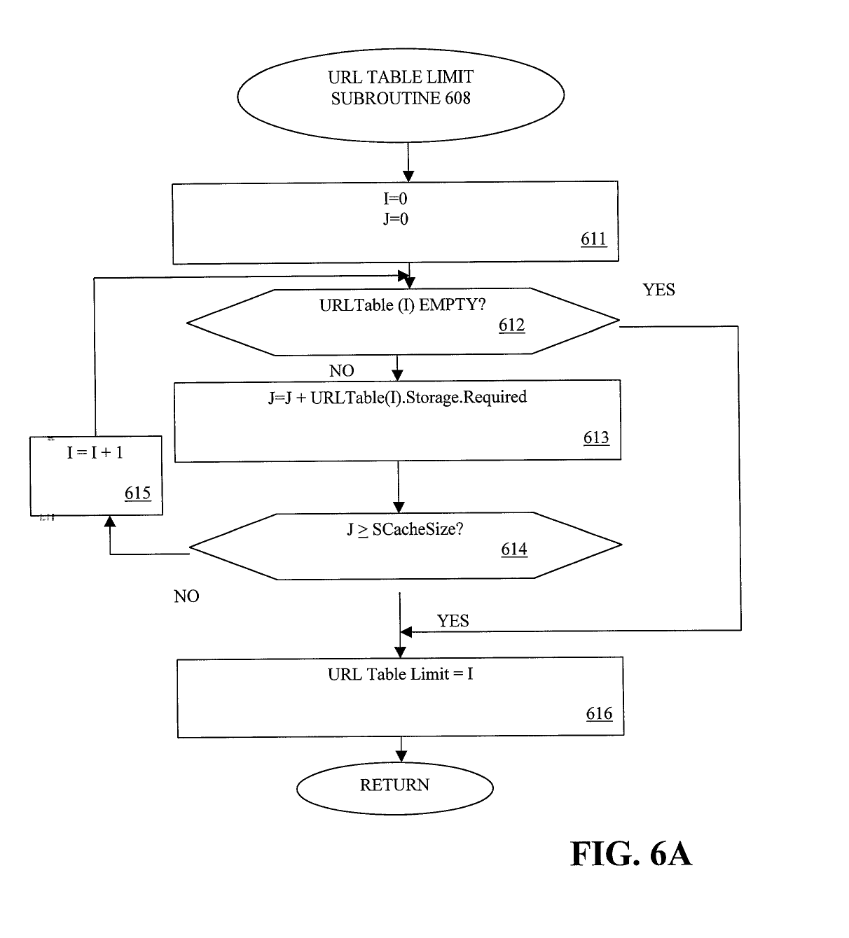

In step 608, a new value for the state variable URL Table Limit is computed using a compute URL Table Limit subroutine 608, discussed further below in conjunction with FIG. 6A. The URL table maintenance process 600 then moves to step 609 to signal to the “consumer” process described in FIG. 7 that content has arrived and the URL table 500 is non-empty. (This signal need only be given once since the table is only deleted when the process halts).

FIG. 6A is a flowchart describing an exemplary implementation of the compute URL Table Limit subroutine 608, performed by the URL table maintenance process 600. As shown in FIG. 6A, the compute URL Table Limit subroutine 608 initiates local variables I and J to 0 during step 611. A test is performed during step 612 to determine if the entry URLTable(I) is empty. If it is determined during step 612 that the entry URLTable(I) is empty, the process goes to step 616, otherwise the process goes to step 613.

In step 613, (which assumes the URLTable(I) is not empty), the local variable J is incremented by an amount equal to the size of the web page indicated by the URL (i.e. URLTable(I).StorageRequired). From step 613, the process moves to step 614 where a further test is performed to see if the current value of J equals or exceeds the operator defined limit SCacheSize (610). If the current value of J equals or exceeds the operator defined limit ScacheSize, then the process goes to step 616, otherwise it goes to step 615.

In step 615, (which assumes J does not exceed SCacheSize) the value of I is incremented, thus I “points” to the next element in the table. The process then moves to step 612 to attempt to add another element.

In step 616, the URL Table Limit is set to the index I. This should correspond to an index into the URL Table 500 reflecting a limit on the entries that are delivered over the broadcast channel over time (i.e., those elements URLTable(I) over the interval I=(0 . . . URL Table Limit) will be periodically broadcast while those above this limit will not be broadcast). Notice that this list will change as the table 500 is updated when new content arrives.

FIG. 7 is a flow chart describing an exemplary implementation of the broadcast download scheduling process 700. As previously indicated, the broadcast download scheduling process 700 determines which content to broadcast and is responsible for issuing pages to be delivered over the broadcast medium based on the information available in the URL table 500. The basic algorithm is a round robin that broadcasts content from the table 500 with a presumption that the steady state rate at which content is delivered is described by a “leaky bucket” algorithm.

A number of state variables are used by the broadcast download scheduling process 700. The UCacheSize variable 713 defines the size of a “virtual” client-side cache presumed to be at the receiver's end (an abstraction of the client side broadcast cache). Notice that this “virtual” cache will not correspond to any real client cache, rather it represents what an “average” user might have in their cache. The variable UCacheModel 714 defines the current fullness of this “virtual” cache at any point in time. The value UCacheDrainInterval 715 is a constant that is used to determine how frequently the list, URLList, is scanned once the “virtual” cache is full (as it normally will be). The value UCacheDrainBytes 716 is a constant that is used to determine how quickly the “virtual” cache will drain. Notice that UCacheDrainBytes/UCacheDrainInterval defines a rate, that is, the imagined client side “leaky bucket.” It is noted that for each entry, if the value refresh interval 506 is greater than the value UcacheDrainInterval, then the content should drop out of the clients cache periodically even with a high normalized Recent hit rate, if the value is less then it should not.

As shown in FIG. 7, during step 701, the broadcast download scheduling process 700 initially initializes the state variable UCacheSize 713 to some number of bytes (less than SCacheSize); the state variable UCacheDrainInterval 715 to some number of seconds; the state variable UCacheDrainBytes 716 to some number of Bytes; the state variable RefeshInterval 717 to some number of Seconds and the state variable UcacheModel equal to zero and the local variable I equal to zero.

During step 702, the broadcast download scheduling process 700 waits for a signal from the “producer” process 600 described in FIG. 6 to provide content into the table 500. The process 700 then moves to step 703, to check if the variable UCacheModel is less than the value UcacheSize. If the variable UCacheModel is less than the value UcacheSize, program control proceeds to step 704 (imaginary client cache has room), otherwise program control proceeds to step 711 (imaginary client cache is full).

During step 704 (which assumes UCacheModel<UCacheSize), the broadcast download scheduling process 700 checks to see if the currentTime minus the last broadcast time of the current URLTable entries is greater than its RefreshInterval 506. If this is true, program control proceeds to step 705, otherwise program control proceeds to step 708.

During step 705 (which assumes the interval since we last sent this entry exceeds our RefreshInterval), the content corresponding to URLTable(I) is sent on the broadcast channel 210. Notice that since URLTable entries are initialized with last broadcast times of zero they will be automatically transmitted the first time (assuming they are ordered high enough in the table 500). The process 700 then moves to step 706, where the variable URLTable(I).Last broadcast is updated to reflect that this element was just sent. The process then proceeds to step 707, where the “virtual” cache UCacheModel is updated with the storage requirements for the element just sent. The process then moves to step 708.

During step 708 (which assumes we have just broadcast content corresponding the current URLTable entry or we wish to skip the current URLTable entry), the URLTable index is advanced by one. The process 700 then moves to step 709, where a test is performed to see if I (the URLTable Index) is greater than URL Table Limit. If I (the URLTable Index) is greater than URL Table Limit, program control proceeds to step 710, otherwise program control proceeds to step 703.

During step 710, the value I (the URLTable index) is reset to zero, looping back to the start of the table. The process then proceeds to step 703.

During step 711 (assumes that UCacheModel is greater or equal to UCacheSize), the value UcacheModel is reduced by the value UCacheDrainBytes 716. The process 700 then proceeds to step 712, in which the process 700 waits for the drain interval UCacheDrainInterval before going back to 703.

FIG. 8 illustrates a data structure 800 for the delivery of category-enhanced web pages. A category-enhanced web page contains additional attributes of the content. These additional attributes correspond to the “Categories” as described in U.S. Pat. No. 6,021,419, incorporated by reference above. As shown in FIG. 8, a category-enhanced web page is presumed to contain a category list 801 and the original content 802, e.g., the web page, encapsulated by some wrapper. The category list 801 is assumed to be a list of categories 803. One possible embodiment for the syntax of the wrapper is the eXtended Markup Language (XML). This syntax is well understood for the expressive way in which it tags data values. In the exemplary embodiment, the category list 803 and web page 802 will be tagged with XML tags marking them as such and the entire content will be sent as an XML structure.

Those skilled in the art will readily understand this mechanism for the delivery of tagged data between computing devices. The techniques of U.S. Pat. No. 6,021,419, incorporated by reference above, may then be used to control, on the client side 300, the selection of material that is deemed to be of interest to a particular user using, for example, the USER-ADD, USER-DELETE and other commands. Notice that the broadcast edge cache server 400 will send material in accordance to the broadcast download scheduling process 700 described in FIG. 7, whereas, the client side will cache only that material of interest to them in accordance with the category/preference lists that have been set up.

### Client-Side Processes

FIG. 9 is a flow chart describing an exemplary implementation of the cache maintenance process 900. As previously indicated, the cache maintenance process 900 processes incoming material received from the broadcast channel and selects the broadcast material that will be stored in the broadcast cache 275. As shown in FIG. 9, the cache maintenance process 900 initially receives a category enhanced web page 800 over the broadcast channel 210 during step 901. A test is then performed during step 902 to determine if the category in the category enhanced web page 800 matches the users preference list as described in U.S. Pat. No. 6,021,419. If the category list provides a match with the user's preference, program control proceeds to step 904, otherwise program control proceeds to step 903.

In step 903 (which assumes that the category list does not provide a match with the users preferences), the category enhanced web page is discarded and the process returns to step 901.

In step 902 (which assumes that the category list does provide a match with the users preferences), a test is performed to see if the broadcast cache 275 has space available for the new web page. If space is available for the new web page, then the process moves to step 905, otherwise program control proceeds to step 906.

In step 906 (which assumes that there is no space in the broadcast cache for the new web page), the least recently used web pages are deleted from the broadcast cache 275 to accommodate the new page. It is noted that to support this, it is necessary that each time a cached web page is used by the client, its recent usage must be recorded (e.g., by maintaining a timestamp associated with it in the broadcast cache 275) as must an efficient way for deleting the least recently used pages. The process then continues to step 905.

In step 905 (which assumes that there is space in the broadcast cache 275 for the new web page), the new category enhanced web page 800 is inserted into the broadcast cache 275 and made available to the user. The process then returns to step 901 waiting for the next page to be delivered.

FIG. 10 is a flow chart describing an exemplary implementation of the web request handling process 1000. As previously indicated, the web request handling process 1000 obtains requested content in accordance with the present invention by determining if it is available in the local cache 270 or broadcast cache 275 before accessing the edge server cache 230 or the original web site 220. As shown in FIG. 10, the web request handling process 1000 initially receives a user request from within a browser (or some other Web accessing component) for a URL.

In step 1002, a test is made to see if this request can be satisfied from the local cache 270 and if so, the process moves to step 1003, otherwise the process moves to step 1004. In step 1003 (which assumes the URL request can be handled by the local cache 270), the process 1000 responds to the users request with the locally stored material. The process has then completed the users request and moves to step 1010.

In step 1004, (which assumes the material is unavailable from a local cache 270), a request for the material is issued against the broadcast cache 275. If the URL is in the broadcast cache, the process moves to step 1005, otherwise program control proceeds to step 1006.

In step 1005 (which assumes the material is available in the broadcast cache 275), the material in the broadcast cache 275 is passed to the user and the process moves to step 1010.

In step 1006 (which assumes the material is unavailable in the broadcast cache 275), the request is then issued to the relevant web host using the http protocol and program control proceeds to step 1007.

In step 1007, the request may be intercepted by a web edge server cache 230 (e.g., an Akamai server) which then checks to see if this request can be served from its cache. This step requires access to the Internet over the bi-directional channel 215. If the material is available in the edge server 230, the process 1000 moves to step 1008, otherwise program control proceeds to step 1009.

In step 1008 (which assumes the edge server 230 has the material), the edge server 230 responds to the request with the cached material thus speeding up the response time and reducing inter-network traffic. Program control then proceeds to step 1010.

In step 1009 (which assumes that the edge server 230 does not have the material available), the request continues to the host site which returns the relevant material.

In step 1010, the material can then be viewed by the user. Program control then terminates.

In addition to the many benefits described above, the broadcast edge server can be used to deliver other sorts of information material in addition to Web pages. In particular, one innovation that is derived from the notion of a broadcast edge cache server 400 and associated broadcast cache is the ability to include common materials that might be relevant to many users simultaneously or substantially simultaneously with the differences in materials being sent over the bidirectional link 215. For example, an interactive game might be used by many hundreds of users at the same time. In this event, the broadcast channel 210 can be used to deliver the common content (e.g., background scenes) to all of the users at once, while the user specific information takes place over the point to point link 215. As with the other innovations, the advantage of this approach is the apparent increase in web access speed by using the technique.

As is known in the art, the methods and apparatus discussed herein may be distributed as an article of manufacture that itself comprises a computer readable medium having computer readable code means embodied thereon. The computer readable program code means is operable, in conjunction with a computer system, to carry out all or some of the steps to perform the methods or create the apparatuses discussed herein. The computer readable medium may be a recordable medium (e.g., floppy disks, hard drives, compact disks, or memory cards) or may be a transmission medium (e.g., a network comprising fiber-optics, the world-wide web, cables, or a wireless channel using time-division multiple access, code-division multiple access, or other radio-frequency channel). Any medium known or developed that can store information suitable for use with a computer system may be used. The computer-readable code means is any mechanism for allowing a computer to read instructions and data, such as magnetic variations on a magnetic media or height variations on the surface of a compact disk.

It is to be understood that the embodiments and variations shown and described herein are merely illustrative of the principles of this invention and that various modifications may be implemented by those skilled in the art without departing from the scope and spirit of the invention.

What is claimed is:

1. A method for selecting digital content for broadcast delivery to multiple users, said method comprising the steps of:
identifying content of interest to multiple users; and
broadcasting said content of interest to multiple users for storage in a client-side cache.

2. The method of claim 1, wherein the step of identifying content of interest to multiple users further comprises the step of statistically analyzing recent user requests for content.

3. The method of claim 1, wherein the step of identifying content of interest to multiple users further comprises the step of analyzing a user profile for each of said users.

4. The method of claim 1, wherein the step of broadcasting said content further comprises the step of broadcasting said content of interest to said plurality of client-side caches until an estimated client-side cache size limit is reached.

5. A method for selecting digital content for broadcast delivery to multiple users, said method comprising the steps of:
determining a server cache size limit;
identifying content of interest to multiple users;
limiting said content of interest to said server cache size limit; and
broadcasting said content of interest to multiple users for storage in a client-side cache.

6. The method of claim 5, wherein the step of identifying content of interest to multiple users further comprises the step of statistically analyzing recent user requests for content.

7. The method of claim 5, wherein the step of identifying content of interest to multiple users further comprises the step of analyzing a user profile for each of said users.

8. A method for selecting digital content for broadcast delivery to a plurality of client-side caches, said method comprising the steps of:
determining an estimated client-side cache size limit;
identifying content of interest to multiple users;
broadcasting said content of interest to said plurality of client-side caches until said estimated client-side cache size limit is reached; and
waiting for a drain interval when said estimated client-side cache size limit is reached.

9. The method of claim 8, wherein the step of identifying content of interest to multiple users further comprises the step of statistically analyzing recent user requests for content.

10. The method of claim 8, wherein the step of identifying content of interest to multiple users further comprises the step of analyzing a user profile for each of said users.

11. A method for storing digital content in a client-side cache, said method comprising the steps of:
receiving content broadcast from a central server;
storing said received content in said client-side cache if said content is of interest to a user;
determining if requested content is in said client-side cache before requesting said content from a remote source.

12. The method of claim 11, wherein said step of storing said received content if said content is of interest to a user compares a category of said content to one or more categories selected by said user.

13. The method of claim 11, wherein said step of storing said received content if said content is of interest to a user evaluates a user profile.

14. The method of claim 11, further comprising the step of requesting said content from an edge server if said requested content is not in said client-side cache.

15. The method of claim 11, further comprising the step of requesting said content from a provider of said content if said requested content is not in said client-side cache.

16. The method of claim 11, further comprising the step of requesting said content from said remote source using a lower capacity link than a link that receives said content broadcast from a central server.

17. A system for selecting digital content for broadcast delivery to multiple users, comprising:
a memory that stores computer-readable code; and
a processor operatively coupled to said memory, said processor configured to implement said computer-readable code, said computer-readable code configured to:
identify content of interest to multiple users; and
broadcast said content of interest to multiple users for storage in a client-side cache.

18. A system for storing digital content in a client-side cache, comprising:
a memory that stores computer-readable code; and
a processor operatively coupled to said memory, said processor configured to implement said computer-readable code, said computer-readable code configured to:
receive content broadcast from a central server;
store said received content in said client-side cache if said content is of interest to a user;
determine if requested content is in said client-side cache before requesting said content from a remote source.

19. An article of manufacture for selecting digital content for broadcast delivery to multiple users, comprising:
a computer readable medium having computer readable code means embodied thereon, said computer readable program code means comprising:
a step to identify content of interest to multiple users; and
a step to broadcast said content of interest to multiple users for storage in a client-side cache.

20. An article of manufacture for storing digital content in a client-side cache, comprising:
a computer readable medium having computer readable code means embodied thereon, said computer readable program code means comprising:
a step to receive content broadcast from a central server;
a step to store said received content in said client-side cache if said content is of interest to a user;
a step to determine if requested content is in said client-side cache before requesting said content from a remote source.
